(19) United States
(12) Patent Application Publication
(10) Pub. No.: US 2022/0191642 A1
(43) Pub. Date: Jun. 16, 2022

(54) PARTICIPANT MULTITRACK INTERACTIVE EXPERIENCE ARCHITECTURE, SYSTEM AND METHOD

(71) Applicant: Gamotics, Peekskill, NY (US)

(72) Inventor: David Edward Carpenter, Peekskill, NY (US)

(21) Appl. No.: 17/558,553

(22) Filed: Dec. 21, 2021

Related U.S. Application Data
(63) Continuation-in-part of application No. 16/112,247, filed on Aug. 24, 2018.
(60) Provisional application No. 62/550,555, filed on Aug. 25, 2017.

(51) Int. Cl. H04W 4/021

(52) U.S. Cl. CPC H04W 4/021

(57) ABSTRACT

Embodiments enabling multitrack interactive experiences for participants of various events. Other embodiments may be described and claimed.

### TECHNICAL FIELD

Various embodiments described herein relate generally to interactive experiences for participants of various events.

### BACKGROUND INFORMATION

It may be desirable to create and enable multitrack interactive experiences for participants of various events, the present invention enables such experiences.

### BRIEF DESCRIPTION OF THE DRAWINGS

FIG. 1A is a block diagram of multitrack interactive participant experience architecture (MIPE) according to various embodiments.

FIG. 1B is a block diagram of another multitrack interactive participant experience architecture (MIPE) according to various embodiments.

FIG. 1C is a block diagram of another multitrack interactive participant experience architecture (MIPE) according to various embodiments.

FIG. 2A is a diagram of communications between devices and systems in MIPE according to various embodiments.

FIG. 2B is a diagram of communications between devices and systems in MIPE for multiple participants according to various embodiments.

FIG. 3A is a block diagram of MIPE providing a participant experience interface to a user or participant device according to various embodiments.

FIG. 3B is a block diagram of MIPE providing a participant experience event to a user or participant device according to various embodiments.

FIG. 3C is a block diagram of MIPE providing an experience control system (ECS) experience setup interface to an ECS according to various embodiments.

FIG. 4 is a block diagram of an experience control system (ECS) according to various embodiments.

FIG. 5A is a flow diagram illustrating several methods according to various embodiments.

FIG. 5B is a diagram illustrating multitrack events for participants according to various embodiments.

FIG. 6A is a block diagram of an article according to various embodiments.

FIG. 6B is a block diagram of an article according to various embodiments.

### DETAILED DESCRIPTION

Creators (such as producers, actors, directors, artistes, writers, architects, and other creative individuals or entities), may produce interactive experience(s) for participants including various events via various embodiments of the invention. The event(s) provided or available to participant(s) may vary as a function their interaction with previous event(s), enabling different participant(s) to create their own experience or affect the experience(s) of other participant(s).

In an embodiment, Experience(s) may be spread over different locations, times, systems, and realities. Participant(s) of experience(s) may shape future experience(s) for themselves or others via their interactions with event(s) of their experience(s). The experience(s) may include in-person experience(s), virtual (such as via perception via an electronic device providing one or more sensual inputs (such as visual, auditory, taste, smell, and tactical), and combination thereof.

In an embodiment, the creators may form/develop the experiences, event(s), and flow of event(s) and experience prior to its interaction by participants, modify or develop as participant(s) interactive with event(s) in experience(s), or a combination thereof. For live experiences, the creators may also control system(s) associated with the event(s) or experience(s) including system(s) that affect the perception(s) of participant(s) of the experience(s) and event(s).

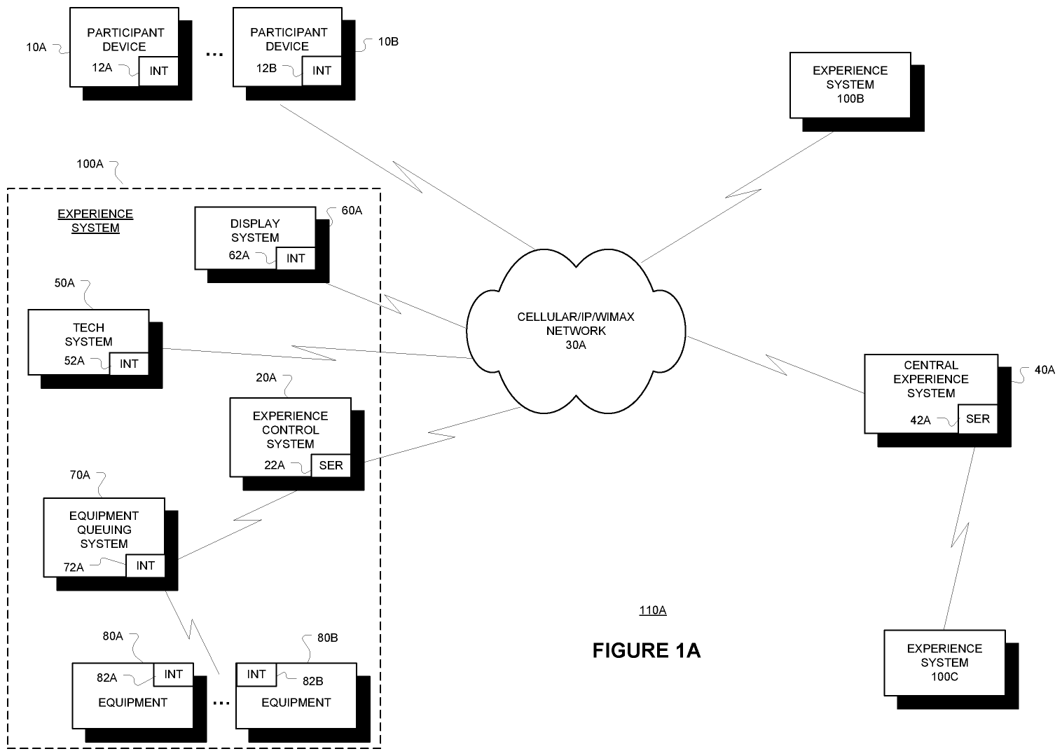

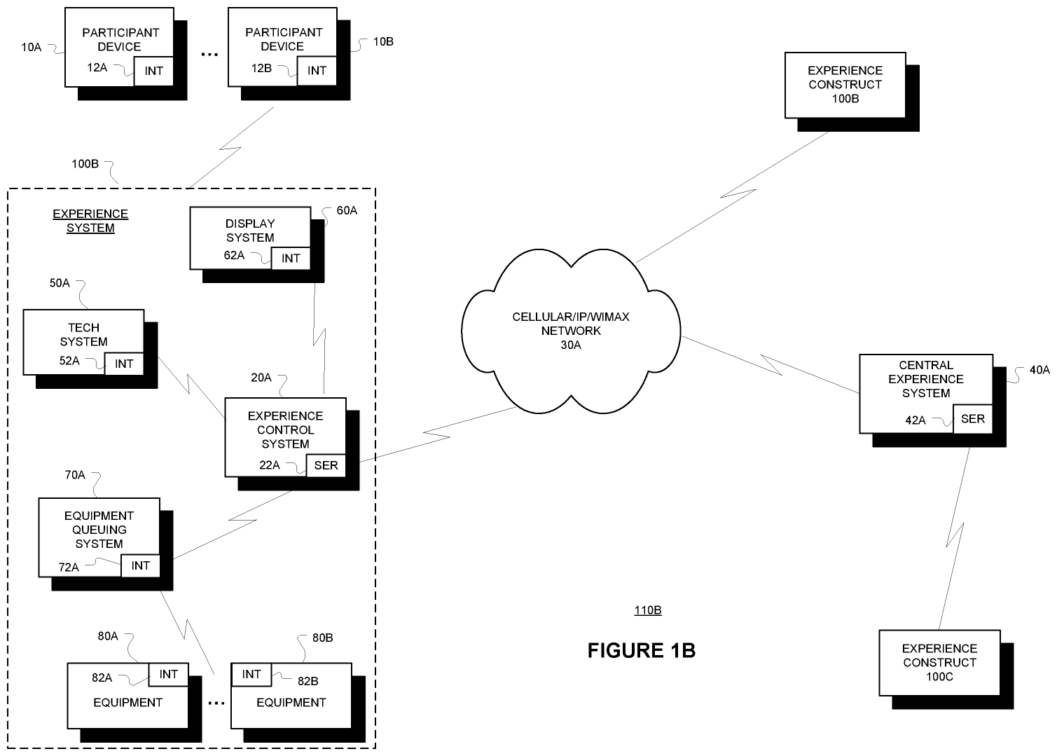

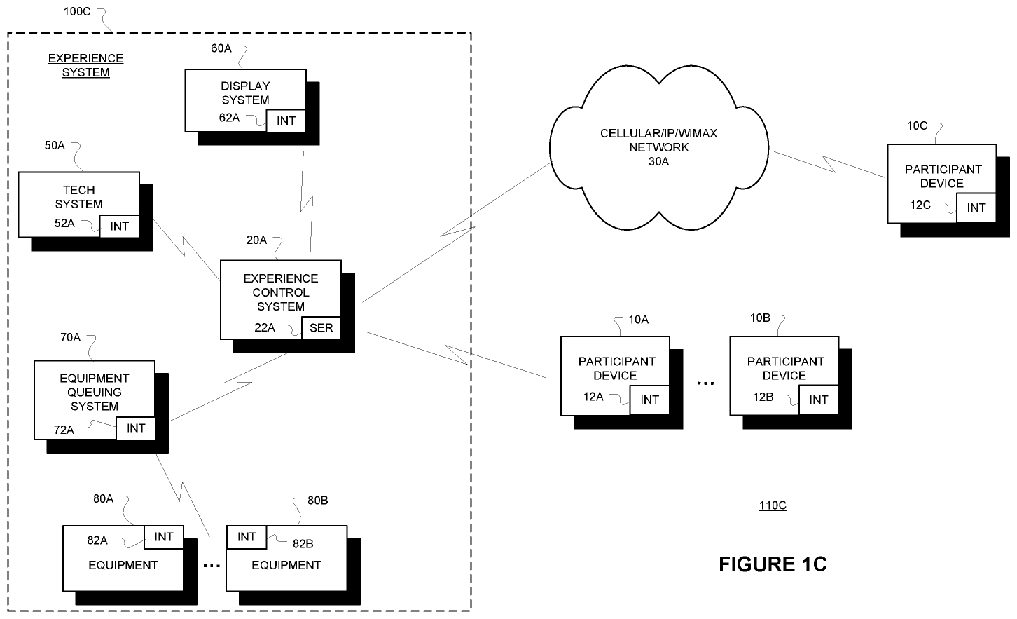

FIGS. 1A-C are block diagrams of multitrack interactive participant experience architectures (MIPE) 110A-C according to various embodiments. As shown in FIG. 1A, multitrack interactive participant experience architecture (MIPE) 110A may include a central experience system (CES) 40A coupled to one or more experience systems (ES) directly (100C) or indirectly (100A and 100B) via a network 30A. In an embodiment, a creator may create/develop experience(s), event(s), and flow(s) via an ES 100A-C or the experience control system (ECS) 20A. The ES 100A-C or ECS 20A may include software enabling a creator to create/develop experience(s), event(s), and flow(s) where the software may be provided by a CES 40A. In another embodiment, an ES 100A-C or ECS 20A via local software and in combination with software executing on a CES 40A, may enable a creator to create/develop experience(s), event(s), and flow(s) that are invoked by a ES 100A-C, ECS 20A of the 100A, CES 40A, or combination thereof for interaction with participant(s).

In an embodiment, a first ES 100A-C may be used to enable a creator to create/develop experience(s), event(s), and flow(s) via an experience control system 20A (with or without a CES 40A). A second, different ES 100A-C may then be used to invoke created experience(s), event(s), and flow(s) for participant(s) interaction via an experience control system 20A (with or without a CES 40A). An ES 100A-C may include or control the operation of one or more participant sensory generation systems 60A, 80A, and 80B and experience(s)/event(s) control systems 50A, 70A via the ECS 20A (FIG. 1B), another ES 100B-C, or CES 40A alone or combinations thereof. For example, where participant(s) are located, a display system 60A may provide visual and auditory event(s) and status of event(s) and experience(s).

A tech or technical system 50A may provide information about experience(s) or event(s) being presented or to be presented to participant(s). A technician (related to the experience(s) or event(s)) may receive directions as a function of the experience(s) or event(s) being presented to participant(s). In an embodiment, a technician may control the presentation of the experience(s) or event(s) being presented to participant(s). The equipment queuing system 70A may control participant sensory generation equipment 80A, 80B based on the experience(s) or event(s) being presented to participant(s) via the ECS 20A, another ES 100B-C, and CES 40A. In an embodiment, the equipment 80A, 80B may generate air movement with different temperatures, humidity, and scents, or combinations thereof. As shown in FIG. 1C, an MIPE 110C may include an ES 100C coupled locally to participant devices 10A, 10B and remotely via a network 30A to other participant devices 10C.

As shown in FIGS. 1A-C, the systems 20A, 50A, 60A, 70A, and 80A may include interfaces 22A, 52A, 62A, 72A, and 82A that enable the systems to communicate data via wired or wireless protocols. It is also noted that in an embodiment the display system 60A may be combined with the experience control system 20A depending on the production. Similarly, the tech systems 50A may be combined with the experience control system 20A depending on the production. Additionally, the equipment queuing system 70A may also be combined with the experience control system 20A depending on the production. In an embodiment, a participant device 10A-C, may be any electronic device including a portable electronic device provided to a participant or the participant's own electronic device (ED). Experience(s) and event(s) may be communicated via participant(s)' ED wirelessly including via AD HOC, peer to peer, cellular, local WIFI, or other wireless communication platforms.

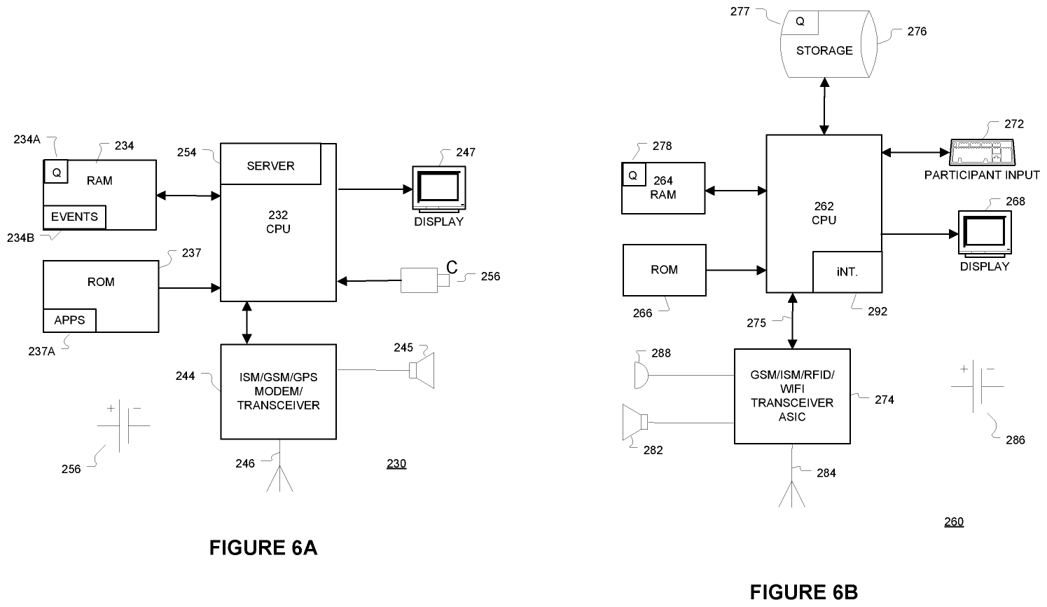

In an embodiment, a network 30A, 30B may be a local network or a network of networks. A PD 10A-B and systems 50A, 60A, 70A, and 80A may include interfaces 12A, 12B, 52A, 62A, 72A, and 82A that may include an interface (network interface controller (NIC)) and ECS 20A, CES 40A, 40B may include a transceiver 244 that enables IP based communication with any systems 20A, 40A, 50A, 60A, 70A, and 80A. The interface 12A, 12B, 52A, 62A, 72A, and 82A may include a modem/transceiver 274 (274, FIG. 6B). The modem/transceivers 244, 274 may include an application specific integrated circuit (ASIC). The network 30A, 30B may be a local network, a network of networks, or a worldwide network of networks, termed the “Internet”, cellular network, or WiMAX networks. In an embodiment, a PD 10A-B and systems 20A, 40A, 50A, 60A, 70A, and 80A may communicate with systems 20A, 40A, 50A, 60A, 70A, and 80A via several networks. It is noted that in an embodiment, the networks 30A, 30B may be industrial, scientific and medical (ISM) radio bands, Groupe Special Mobile (GSM), Code-division multiple access (CDMA), time division multiple access (TDMA), mesh, and short messaging system (SMS) based network, WiMAX, IP (wired or wireless network) such as 802.11a, b, g, n networks.

In an embodiment, a PD 10A-B and systems 20A, 40A, 50A, 60A, 70A, and 80A may be a cellular device such an iPhone® or other smartphone, tablet device including an iPad®, laptop, tablet, desktop, or other electronic device capable of communicating via one or more wired or wireless protocols. In an embodiment, a ECS 20A, CES 40A, 40B may be an electronic device 240 that may include a transceiver 244 to communicate signals with a PD 10A-B and systems 20A, 40A, 50A, 60A, 70A, and 80A and may also include a server 22A, 42A, 42B (254, FIG. 6A).

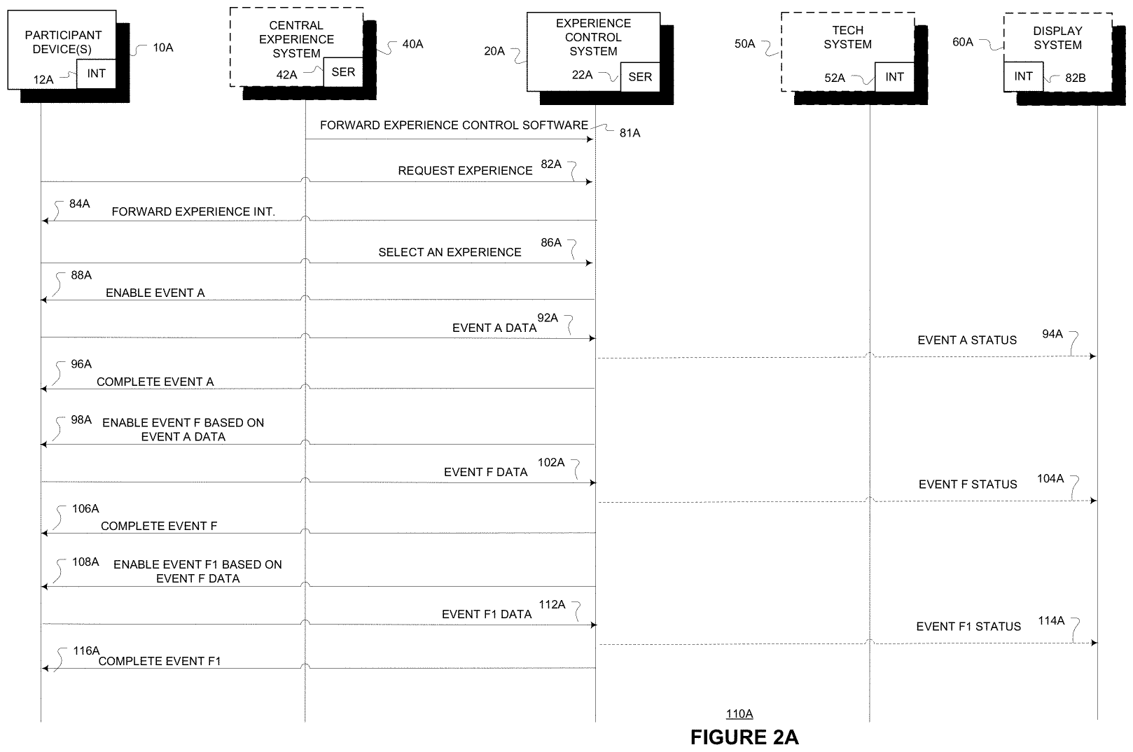

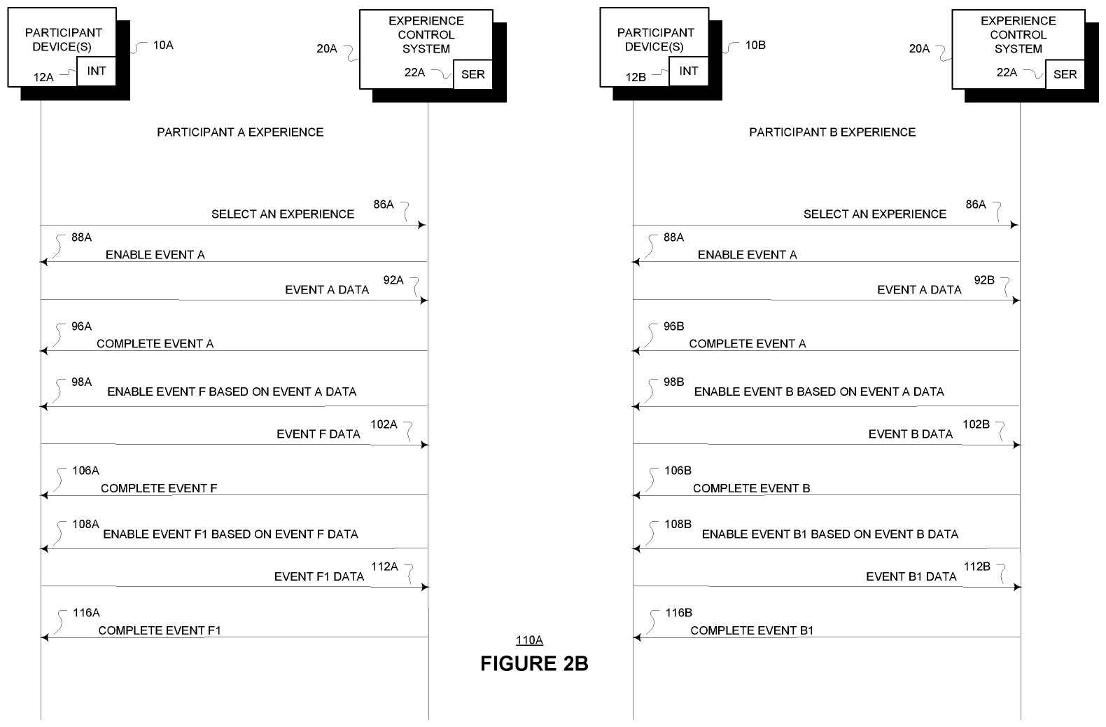

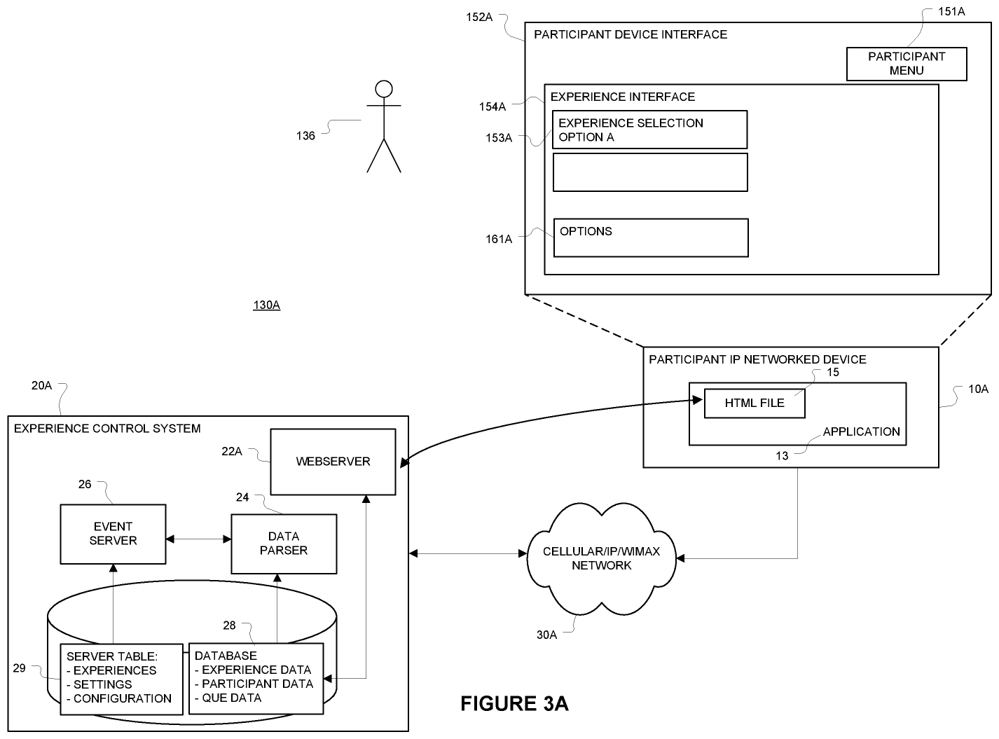

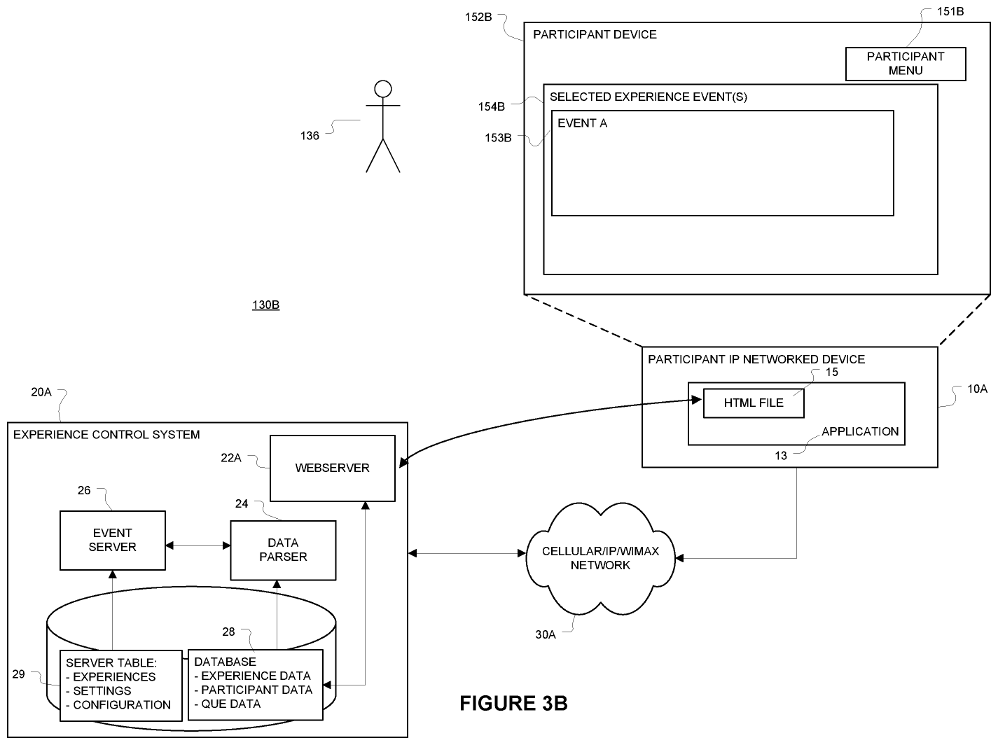

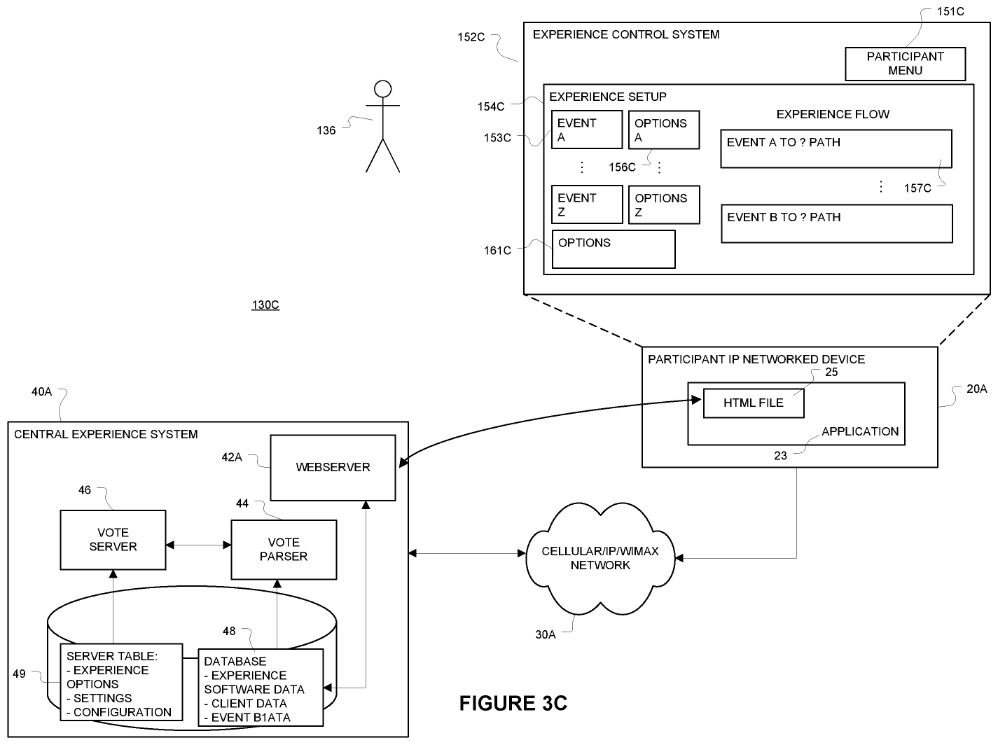

FIG. 2A is a diagram of communications between a CES 40A, a participant device 10A, an experience control system 20A, a tech system 50A, and a display system 60A in a multitrack interactive participant experience architecture 110A-C according to various embodiments. FIG. 2B is a diagram of communications between PDs 10A, 10B for two participants 136 in MIPE 110A-C with ECS 20A according to various embodiments. In an embodiment and shown in FIGS. 2A and 2B, the ECS 20A may receive experience control software from the central experience system 40A (communication 81A). The experience control software may enable a ECS 20A to program experiences and events for participants—the flow of interactions participant(s) may perceive such as via the interface 152C shown in FIG. 3C. The ECS 20A experience control system may automate the presentation of experience(s) and event(s) based on the interactions of the participant(s) to the event(s) during various experience(s).

In an embodiment, event(s) may be associated with experience(s) and participant(s) may receive different event(s) (downstream) based on their interaction with past event(s). Participant(s) may all receive or be presented the same experience(s) in an embodiment, but different event(s) as a function of their interactions with past event(s) in an embodiment. In another embodiment, participant(s) may all receive or be presented the same initial experience(s) in an embodiment, but different event(s) and experience(s) as a function of their interactions with past event(s).

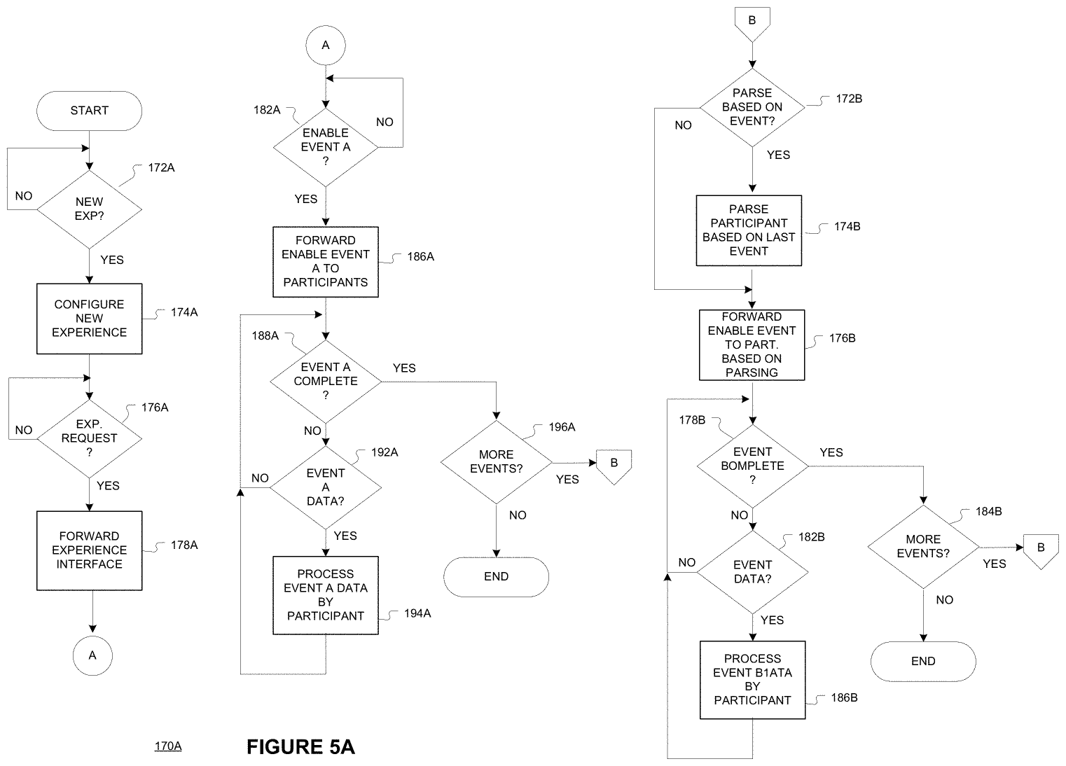

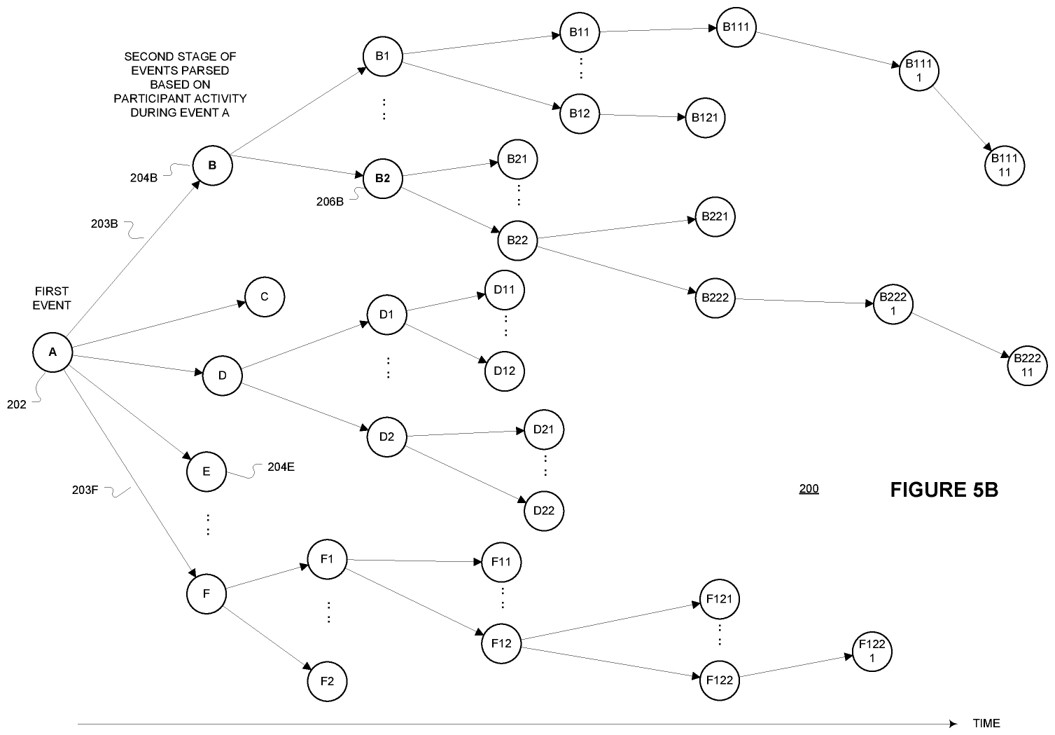

With reference to algorithm 170A shown in FIG. 5A, when an experience provider wants to create a new experience (activity 172A) they may employ local, application as a service, or interactive interface via web interface from a CES 40A via their ECS 20A to configure one or more new experience(s) (activity 174A). Their ECS 20A may provide the interface 152C shown in FIG. 3C to configure a new experience. As shown in FIG. 3C, an experience may include one or more event(s) A to Z 153C that may have options. The flow between event(s) in an experience may also be configured via an experience flow 157C. In an embodiment, a CES 40A may provide a web-based experience formation interface for a ECS 20A as shown in FIG. 3C. In other embodiments, a CES 40A may provide software operatable on a ECS 20A that enables an experience provider to generate experience(s) with event(s). In an embodiment, the event(s) that an experience operator may select via a ECS 20A may be selectable from two or more different configurable event(s). The configurable event(s) available may also vary based on the experience being generated and its linkage to previous event(s) in the flow.

An experience provider via a ECS 20A may be able to create complex event flows for execution/delivery when an experience is requested by participant(s) or in real time including an event flow 200 shown in FIG. 5B. As shown in FIG. 5B, an experience may include a variety of events and flows between events that an experience provider may generate. In an embodiment, an event may be any electronic content providable to a participant device (PD) 20A and may include multimedia content and enable a participant to interact with the event, such as event A 202 of FIG. 5B.

In the experience flow 200 shown in FIG. 5B, an event A presented to a participant via their PD 10A may have five, different flows therefrom depending on the participant(s)' interaction with Event A 202. As a function of the participant interaction, a participant may be presented with an Event B-F (204B, 204E) along flows 203B, 203F. Some events may have many downstream (in time) possible events—such as event B, which could lead to event B2, B22, B222, B2221, and B22211 in an embodiment, whereas Event C may have no further associated downstream events.

As shown in FIGS. 2A, a participant via a PD 10A may request to participate in an experience (communication 82A and activity 176A—FIG. 5A) and receive an experience interface (communication 84A and activity 178A—FIG. 5B) such as the experience interface 154A shown in FIG. 3A. Via interface 154A, a participant via a PD 10A may be able to request one or more available experiences A 153A and associated options 161A. An ECS 20A may provide a participant with a selection of experience(s) as a function of the available experiences and the participants location (as provided by their PD 10A) in an embodiment. Where the experience(s) are provided remotely (participant is not located where the experience is being created in real time) such as via electronically communicated experience(s) that a participant can sense via one or more senses via one or more PD 10A, a participant may be able to elect from one or more “online” experiences.

In an embodiment, a ECS 20A may provide experience multimedia to a participant(s) via their PD 10A, 10B or secondary PD 10A, 10B. For example, a participant may view experience multimedia via a first device such as a desktop, laptop, smart TV, VR system, or other multimedia processing device. Event(s) may be communicated to a participant via a second device (PD 10A, 10B), such as more mobile device including a cellphone, tablet, or other device. In a further embodiment, a participant(s)' PD 10A, 10B may receive both experience multimedia and event(s) multimedia. For example, a smart TV may enable a participant to view experience multimedia and interact with event(s).

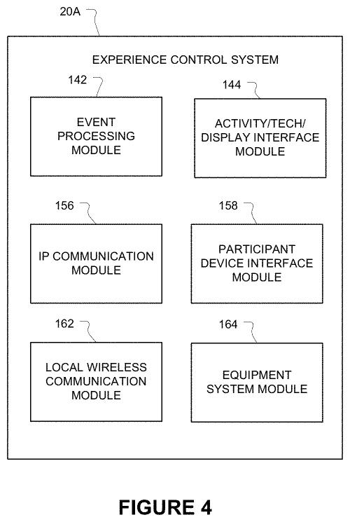

As shown in FIG. 4, an ECS 20A may include several modules including an event processing module 142, activity/tech/display interface module 144, IP communication module 156, participant device interface module 158, local wireless communication module 162, and equipment system module 164. The event processing module 142 may enable various events A-F and process interactive data provided by participants via their PD 10A-B. The activity/tech/display interface module 144 may communicate with and control other components 50A, 60A, 70A of an experience system 100A-C. The IP communication module 156 and the local wireless communication module 162 may enable communications, wired and wirelessly with other components and systems 100B, 10A-B, 40A of MIPE 110A-C.

The participant device interface module 158 may generate program, control, and event data for use by a PD 10A-B in an embodiment. The equipment system module 164 may control the operation of equipment 80A-80B directly or indirectly via the equipment queuing system 70.

When the participant is co-located with the experience(s) to be perceived, a participant may have one or more experience(s) available. For example, when a participant is located at a museum having multiple pathways or exhibits (such as the Louvre in Paris or the Metropolitan Museum of Art in New York City), a participant via their PD 10A may able to select one or many experience(s) that route through different pathways in the physical environment. In such an experience, one or more event(s) may be related the environment along the elected pathway(s). In addition, a response or interaction to an Event A (FIG. 5B), may direct the participant to a different pathway with a physical environment and thus a different experience.

For other experience(s), such as a live theater, sporting, musical, or similar environment, the participant(s) experience may be similar (as a function of where they are located in the environment and their physiology). Events presented to the such participants may enable the participant to affect elements of the live experience and be provided with unique multimedia event(s) as a function of their interactions with previous Events. For example, Event A (such as shown in FIG. 3B) may enable a participant via their PD 10A to elect group A-Z, player A-Z, team A-Z, result A-Z, and other, and their next event(s) may flow from this first choice, or further choices (see FIG. 5B). In an embodiment, the live experiences may be affected by the participants interactions with Events (elections, or other interaction).

In particular, once participant(s) select an experience (communication 86A—FIGS. 2A-B, activity 176A), an experience interface (activity 178A) may be forwarded or activated on a PD 10A. Then automatically or at the direction of an experience moderator or creator via a ECS 20A, an Event (A) may be abled 182A and forwarded for interaction with participant(s) via their PD 10A (activity 186A—communications 88A). Depending on the event, a participant may be able provide some feedback from their interaction—create event data (activity 192A) and a ECS 20A may process the received event data from participant(s) 194A to determine/correlate the data to forward flows (203B-F—FIG. 5B). Based on the event data, a ECS 20A may pass further event(s) to participant(s) via their PD 10A (activity 196A).

This process of event presentation, event data processing and flow to further events may continue as function of developed flow (activities 172B-186B—Flow diagram 200—FIG. 5B). As shown in FIG. 2B, a participant A based on their interaction(s) with Event A (via their PD 10A) may be presented with a different Event F (communications 98A) and progress to Event F1 based on their interaction(s) with Event X (communications 102A-116A). While a participant B based on their interaction(s) with Event A (via their PD 10B) may be presented with a different Event B (communications 98A) and progress to Event B1 based on their interaction(s) with Event B (communications 102B-116B).

In an embodiment, events A-F provided to participant(s) via a PD 10A-B may include multimedia data. An event may include an interactive component that generates event data (communication 92A, 112A in FIG. 2A) that be evaluated by a ECS 20A to determine a participant(s) response—interaction with the provided event A-F data (communications 88A, 102A in FIG. 2A). In an embodiment, a provided or enabled event A-F may enable a participant to compete in various interactive activities including knowledge/trivia activities, gaming activities, experience rated activities, polls, or elections. Participant(s) scores (for knowledge/trivia) and elections-polls may be accumulated and presented to the participant and other participant(s) (such as a leaderboard).

FIG. 6A illustrates a block diagram of a device 230 that may be employed at least in part in a CES 40A, a ECS system 20A, 20B, or system 50, 60, 70, 80, 90 in various embodiments. The device 230 may include a central processing unit (CPU) 232, a random-access memory (RAM) 234, a read only memory (ROM) 237, a local wireless/GPS modem/transceiver 244, a display 247, a camera 256, a speaker 245, a rechargeable electrical storage element 256, and an antenna 246. The CPU 232 may include a control interface 254 including an IP type network controller interface (NIC). The RAM 234 may include a queue or table 234A where the queue 234A may be used to store event data until parsed, web pages, applications, or APIs. The RAM 234 may also include program, algorithm, and system data and instructions. The rechargeable electrical storage element may be a battery or capacitor in an embodiment.

The modem/transceiver 244 may couple, in a well-known manner, the device 230 to a wired or wireless network 30A, 30B to enable communication with other of CES 40A, a ECS system 20A, 20B, or system 50, 60, 70, 80, 90 and PD 10A-10B. The modem/transceiver 244 may also be able to receive global positioning signals (GPS) and the CPU 232 may be able to convert the GPS signals to location data that may be stored in the RAM 234. The ROM 237 may store program instructions to be executed by the CPU 232 or server 254 (applications 237A). The applications 237A may include a web browser program or application.

FIG. 6B illustrates a block diagram of a device 260 that may be employed at least in part in a system 50, 60, 70, 80, 90 or PD 10A-10B in various embodiments. The device 260 may include a central processing unit (CPU) 262, a random-access memory (RAM) 264, a read only memory (ROM) 266, a display 268, a user input device 272, a transceiver application specific integrated circuit (ASIC) 274, a microphone 288, a speaker 282, storage 276, electrical energy storage unit 286, and an antenna 284. The CPU 262 may include an interface 292. The RAM 264 may include a queue 278 where the queue 278 may webpages.

The ROM 266 is coupled to the CPU 262 and may store the program instructions to be executed by the CPU 262 and the interface 292. The RAM 264 may be coupled to the CPU 262 and may store temporary program data, overhead information, and the queues 278. The user input device 272 may comprise an input device such as a keypad, touch pad screen, track ball or other similar input device that allows the user to navigate through menus in order to operate the device 260. The display 268 may be an output device such as a CRT, LCD or other similar screen display that enables the user to read, view, or hear multimedia content.

The microphone 288 and speaker 282 may be incorporated into the device 260. The microphone 288 and speaker 282 may also be separated from the device 260. Received data may be transmitted to the CPU 262 via a serial bus 275 where the data may include messages or pages received, messages, or web pages to be transmitted, or protocol information. The transceiver ASIC 274 may include an instruction set necessary to communicate messages or web pages, applications, APIs, and data via network 30A, 30B. The ASIC 274 may be coupled to the antenna 284 to communicate messages, content, or pages wireless. When a message is received by the transceiver ASIC 274, its corresponding data may be transferred to the CPU 262 via the serial bus 276. The data can include wireless protocol, overhead information, sensor, and pages to be processed by the device 260 in accordance with the methods described herein.

The rechargeable electrical storage element 286 may be a battery or capacitor in an embodiment. The storage 276 may be any digital storage medium and may be coupled to the CPU 262 and may store temporary program data, overhead information, and databases 48, 49.

Any of the components previously described can be implemented in a number of ways, including embodiments in software. Any of the components previously described can be implemented in a number of ways, including embodiments in software. Thus, the devices 230, 260 elements including the RAM 234, ROM 237, CPU 232, transceiver 244, storage 276, CPU 262, RAM 264, ROM 266, and transceiver ASIC 274, may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus, the following claims are hereby incorporated into the Detailed Description, with each claim standing on its own as a separate embodiment.

What is claimed is:

1. A method of providing an interactive experience to a plurality of participants, including:
providing a first interactive event to at least two participants of the plurality of participants, the at least two participants able to perceive the first interactive event via an electronic device and provide feedback data based on their perception via the electronic device and the current state of the interactive event being provided as a function of the interactive experience; and
providing a second, different interactive event to at least one of the at least two participants of the plurality of participants based on their feedback data provided during the first interactive event, the at least one participant able to perceive the second interactive event via an electronic device and provide feedback data based on their perception via the electronic device and the second interactive event being provided as a function of the current state of the interactive experience.

2. The method of providing an interactive experience to a plurality of participants of claim 1, further including providing a third, different interactive event to at least another one of the at least two participants of the plurality of participants based on their feedback data provided during the first interactive event, the at least another one participant able to perceive the third interactive event via an electronic device and provide feedback data based on their perception via the electronic device and the third interactive event being provided as a function of the current state of the interactive experience.

3. The method of providing an interactive experience to a plurality of participants of claim 1, wherein the interactive experience is live and the events are provided sequentially in time to the plurality of participants.

4. The method of providing an interactive experience to a plurality of participants of claim 1, further including changing an attribute of the interactive experience based on the feedback data provided from the at least two participants.

5. The method of providing an interactive experience to a plurality of participants of claim 1, further including changing the flow of the interactive experience based on the feedback data provided from the at least two participants.

6. The method of providing an interactive experience to a plurality of participants of claim 1, wherein the flow of the interactive experience includes where one or more of the plurality of participants move in a physical environment, the performance of one or more people creating the interactive experience, and one or more environmental variables of the interactive experience.

7. The method of providing an interactive experience to a plurality of participants of claim 6, wherein the live experience is located at one of a theater, museum, sports arena, and retail store.

8. The method of providing an interactive experience to a plurality of participants of claim 6, wherein the live experience is located at one of a theater, museum, sports arena, and retail store.

9. The method of providing an interactive experience to a plurality of participants of claim 1, wherein one of the first, second, and third interactive event includes multimedia content.

10. The method of providing an interactive experience to a plurality of participants of claim 1, wherein one of the first, second, and third interactive event includes one of a poll and election and the feedback data includes the participants response to the one of the poll and the election.

11. A method of providing a plurality of interactive experiences to a plurality of participants, including:
enabling at least two participants of the plurality of participants to select one or the plurality of interactive experiences;
providing a first interactive event to at least two participants of the plurality of participants, the at least two participants able to perceive the first interactive event via an electronic device and provide feedback data based on their perception via the electronic device and the current state of the selected one or the plurality of interactive experiences being provided as a function of the selected one or the plurality of interactive experiences; and
providing a second, different interactive event to at least one of the at least two participants of the plurality of participants based on their feedback data provided during the first interactive event, the at least one participant able to perceive the second interactive event via an electronic device and provide feedback data based on their perception via the electronic device and the second interactive event being provided as a function of the current state of the selected one or the plurality of interactive experiences.

12. The method of providing a plurality of interactive experiences to a plurality of participants of claim 11, further including providing a third, different interactive event to at least another one of the at least two participants of the plurality of participants based on their feedback data provided during the first interactive event, the at least another one participant able to perceive the third interactive event via an electronic device and provide feedback data based on their perception via the electronic device and the third interactive event being provided as a function of the current state of the selected one or the plurality of interactive experiences.

13. The method of providing a plurality of interactive experiences to a plurality of participants of claim 11, wherein the selected one or the plurality of interactive experiences is live and the events are provided sequentially in time to the plurality of participants.

14. The method of providing a plurality of interactive experiences to a plurality of participants of claim 11, further including changing an attribute of the selected one or the plurality of interactive experiences based on the feedback data provided from the at least two participants.

15. The method of providing a plurality of interactive experiences to a plurality of participants of claim 11, further including changing the flow of the selected one or the plurality of interactive experiences based on the feedback data provided from the at least two participants.

16. The method of providing a plurality of interactive experiences to a plurality of participants of claim 11, wherein the flow of the selected one or the plurality of interactive experiences includes where one or more of the plurality of participants move in a physical environment, the performance of one or more people creating the selected one or the plurality of interactive experiences, and one or more environmental variables of the selected one or the plurality of interactive experiences.

17. The method of providing a plurality of interactive experiences to a plurality of participants of claim 16, wherein the selected one or the plurality of interactive experiences is located at one of a theater, museum, sports arena, and retail store.

18. The method of providing a plurality of interactive experiences to a plurality of participants of claim 16, wherein the selected one or the plurality of interactive experiences is located at one of a theater, museum, sports arena, and retail store.

19. The method of providing a plurality of interactive experiences to a plurality of participants of claim 11, wherein one of the first, second, and third interactive event includes multimedia content.

20. The method of providing a plurality of interactive experiences to a plurality of participants of claim 11, wherein one of the first, second, and third interactive event includes one of a poll and election and the feedback data includes the participants response to the one of the poll and the election.
